(19) United States
(12) Patent Application Publication
(10) Pub. No.: US 2024/0086433 A1
(43) Pub. Date: Mar. 14, 2024

(54) INTERACTIVE TOOL FOR DETERMINING A HEADNOTE REPORT

(71) Applicant: Thomson Reuters Enterprise Centre GmbH, Zug (CH)

(72) Inventors: Jesse McCrillis Carlson, Cottage Grove, MN (US); Benjamin Petersburg, Bloomington, MN (US); Mark Daniel Baker, New York, NY (US); Stephen McNamara, Inver Grove Heights, MN (US); Sharon Ruth Stanley, Minneapolis, MN (US)

(21) Appl. No.: 18/465,973

(22) Filed: Sep. 12, 2023

Related U.S. Application Data
(60) Provisional application No. 63/405,684, filed on Sep. 12, 2022.

(51) Int. Cl. G06F 16/332; G06F 16/33

(52) U.S. Cl. CPC G06F 16/3328; G06F 16/3334; G06Q 50/18

(57) ABSTRACT

Embodiments support systems and methods for classifying and ranking headnote reports based on a query, and for outputting a highest ranked headnote in response to the query. In an aspect, headnote scores may be calculated for each headnote of a plurality of headnotes to determine a measure of correspondence between a given headnote and the query. In an aspect, a dataset including at least the query, the headnotes, and the headnote scores may be provided to and analyzed by a classifier to produce a set of classifications. In an aspect, the headnote scores and the set of classifications may be determined by at least one machine learning model. In an aspect, the classifications enable the ranking of the headnotes relative to one another, such that the highest ranked headnote may be the headnote most responsive to the query. In an aspect, a method may include outputting the highest ranked headnote.

### CROSS-REFERENCE TO RELATED APPLICATIONS

The present application claims the benefit of and priority to U.S. Provisional Application No. 63/405,684, filed Sep. 12, 2022, and entitled “SYSTEMS AND METHODS FOR DETERMINING A HEADNOTE REPORT,” the content of which is incorporated herein by reference in its entirety.

### TECHNICAL FIELD

The present subject matter is directed generally to data identification, and more particularly to displaying a headnote report in response to a search query.

### BACKGROUND

Many documents rely on the content of other documents when making assertions or providing conclusions. For example, in a first legal case treating a legal issue or point of law, the legal case may rely on a decision or treatment of the issue in a second case. In this sense, the first case may cite the second case. Many other cases may also cite to the second case. When this occurs, a researcher may access and review a large volume of cases for analysis.

While conventional search systems may return a plurality of cases and selected or designated snippets from such cases in response to a particular query, any greater level of analysis using conventional search systems requires manual review of the search results. Displaying a “bright line rule” or a summary of a case's holding, or to otherwise display a headnote of law applied to a set of facts, conventionally requires manual review of all of the returned cases and manually creating a summary of the results. Such manual review may create inaccurate or incomplete summaries of the law, in addition to being time consuming and likely beyond what is permitted by the client. Citation systems lack functionality to address the above situation where conventional search results are presented at best as a long list of cases for review and selected snippets from such cases that do not include an optimized indication of relevance in the form of a headnote from each result tailored to the user's search. Thus, existing citation systems lack the ability to quantify a relevancy of headnotes with respect to a point of law of interest and mechanisms to generate graphical user interfaces that can present headnotes in a more meaningful way than simple lists of results and selected snippets from such cases.

### SUMMARY

Systems and methods are disclosed herein for headnote representations of a search to address the aforementioned shortcomings of conventional citation systems. The systems and methods may use data analytics to generate an optimized headnote for a point of law and may account for how the point of law addressed by the optimized headnote may be applied to a set of facts. The optimized headnote may provide for a rapid dissemination of the law with more relevant information, data, and attributes than may be provided by manual review. The optimized headnote may provide a user with a summary of the relevant law based on a search query.

In an aspect of the disclosure, a method is provided for generating a headnote result. The method may include generating, by one or more processors, a set of headnote scores for a plurality of headnotes, wherein each headnote score of the set of headnote scores corresponds to a particular headnote of the plurality of headnotes, and wherein the headnote score is generated for each headnote based on a query. The method may include applying, by the one or more processors, a classifier to a dataset to generate a set of classifications, wherein the dataset comprises the headnote score, the query, and information associated with at least a subset of headnotes of the plurality of headnotes, and wherein the set of classifications comprises a classification for each headnote of the subset of headnotes.

According to aspects of the disclosure, the method may include ranking, by the one or more processors, the subset of headnotes, based at least in part on the set of classifications and the set of headnote scores to produce a ranked set of headnotes, wherein the ranked set of headnotes is configured to quantify a relevance of each headnote of the subset of headnotes to the query, wherein a first headnote score corresponding to a first headnote of the subset of headnotes is based on information associated with a first portion of the first headnote and wherein a ranking of the first headnote is based on information associated with a second portion of the first headnote, and wherein the information associated with the first portion of the first headnote is different from the information associated with the second portion of the first headnote.

In an aspect, the method may include outputting, by the one or more processors, a highest ranked headnote (e.g., an optimized headnote) based on the ranked set of headnotes.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

For a more complete understanding of the present disclosure, reference is now made to the following descriptions taken in conjunction with the accompanying drawings, in which:

FIG. 1 shows a block diagram of a feature ranking system in accordance with aspects of the present disclosure;

FIG. 2 shows a diagram illustrating exemplary scoring data generated in accordance with aspects of the present disclosure;

FIG. 3 shows a block diagram illustrating an example architecture for a scoring model in accordance with aspects of the present disclosure;

FIG. 4 illustrates an exemplary graphical user interface for displaying information associated with search results and/or headnotes obtained in accordance with aspects of the present disclosure; and

FIG. 5 is a flow diagram of an exemplary method for outputting a headnote in accordance with aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

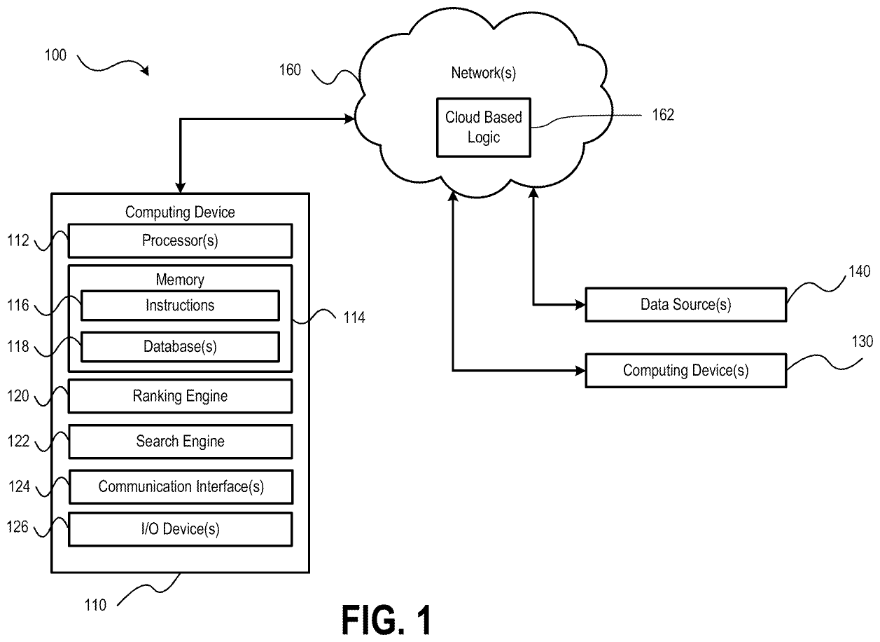

Referring to FIG. 1, a block diagram of a feature ranking system in accordance with aspects of the present disclosure is shown as a system 100. The system 100 may be configured to receive a query and in response to the query, generate a headnote relevant to the query. The headnote generated will ideally be an optimized headnote (e.g., a headnote that is determined to be highly relevant to the query, to the extent that it is not the most relevant headnote to the query). In an aspect, the system 100 may also provide functionality for searching for headnotes based on a query and/or inputs to a graphical user interface. The system may also be configured to display headnote results obtained in accordance with aspects of the disclosure. Exemplary details regarding the above-identified functionality of the system 100 are described in greater detail below.

As illustrated in FIG. 1, the system 100 includes a computing device 110 that includes one or more processors 112, a memory 114, a ranking engine 120, a search engine 122, one or more communication interfaces 124, and input/output (I/O) devices 126. The one or more processors 112 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 114 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may also store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 124 may be configured to communicatively couple the computing device 110 to the one or more networks 160 via wired and/or wireless communication links according to one or more communication protocols or standards. The I/O devices 126 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

The one or more databases 118 may be configured to store information and/or documents. For example, the one or more databases 118 may include one or more headnotes databases for storing headnotes. Headnotes, also known as headnote reports, are summaries of specific points of law addressed in a particular case. Headnotes are typically included at the beginning or head of a case document and usually have a corresponding notation in the document indicating the text to which the headnote refers. A court case document case may include or correspond to multiple headnotes, each created to identify and/or summarize a particular point of law. In some instances, a case may not include any headnotes. In some instances, headnotes may include verbatim quotes or summaries from a case document. In other instances, headnotes may be drafted to include or correspond to specific topics or factual and legal findings discussed in a case document. In additional or alternative implementations, headnotes may be generated by a computer (e.g., by a generative artificial intelligence (AI)), by a human drafter, or by a combination thereof. Headnotes may be abstract or concrete. Concrete headnotes are headnotes in which a legal result is paired with corresponding material facts. A non-limiting example of a concrete headnote includes: “statement by declarant was admissible under hearsay exclusion for excited utterances because it was made while still in immediate vicinity of traumatic event.” An abstract headnote is a headnote in which the headnote states a principle of law without reference to the material facts underlying a given case. A non-limiting example of an abstract headnote includes “statements made in the immediate vicinity of traumatic events are admissible in evidence.” In other words, concrete headnotes include the law as applied to a set of facts, and abstract headnotes include black-letter statements of law.

Headnotes may include text (e.g., a summary of the specific point of law identified by a headnote). Headnotes may also include or correspond to metadata. The one or more databases 118 may include or correspond to one or more metadata databases for storing metadata. Metadata may include information that gives context or additional data about a case, a document, a headnote, a point of law summarized by a headnote, and the like. For example, metadata for a headnote may include or correspond to a topic, a narrow legal issue, a legal issue outcome, a narrow legal issue as paired with a legal issue outcome, one or more material facts, one or more fact patterns, a level of concreteness (e.g., concrete or abstract), one or more causes of action, one or more party types, one or more governing laws (e.g., a state law, a federal law, an administrative rule, and so on), one or more motion types (e.g., motion to dismiss, motion for summary judgment, motion to stay, motion for judgment as a matter of law, and so on), one or more motion outcomes, one or more motion types as paired with motion outcomes, one or more areas of law (e.g., contracts, torts, product liability, criminal law, cybersecurity, or any number of additional areas of law), a headnote number, or some combination thereof.

The one or more databases 118 may include or correspond to one or more document databases for storing documents. Non-limiting examples of documents that may be stored in a document database include case law documents, statutes, legal codes, legal briefs, legal motions, journal articles, treatises, and/or news articles. Additionally or alternatively, headnotes, documents, metadata, and/or other information may be stored on and/or retrieved to the computing device 110 from other devices such as, for example, computing device(s) 130 or from a data source and/or plurality of data sources, such as, for example, data source(s) 140. Such devices and/or data sources may be communicatively coupled with the computing device 110 through the one or more networks 160.

The ranking engine 120 may be configured to identify relevant headnotes in response to a query, score and/or classify the headnotes based at least in part on the query, rank the headnotes, determine a headnote that is most relevant to the query, or some combination thereof. The search engine 122 may be configured to generate search results in response to the query. Aspects of this functionality are described in greater detail below.

The ranking engine 120 may be configured to receive a query. A query may include, for example, search terms, keywords, questions, natural language inputs, a selection of selectable elements, Boolean operators (e.g., AND, OR, NOT), grammatical connectors (e.g., operators designed to search for connections between terms based on grammar, such as by sentence structure), numerical connectors (e.g., operators designed to search for connections between terms based on the number of terms between and/or preceding them), or some combination thereof. A query may be generated by input by a user, such as through one or more of the I/O devices 126.

In some implementations, a query may be generated based on inputs received via selectable elements of a graphical user interface (GUI). For example, the inputs may include selecting one or more of a plurality of selectable elements. In some implementations, selectable elements may include or correspond to attributes of interest (e.g., search parameters). Such attributes of interest may be built into a template format, such that users could select attributes of interest from the template and generate a query. The query in such a case would be configured with search parameters corresponding to the selected attributes of interest. Such attributes of interest could also provide a measure of prefiltering to text-based queries, whether the text-based queries are generated concurrently within the template or entered after the attributes of interest have already been selected. In some such implementations, the inputs to the selectable elements may include or correspond to a legal issue outcome, a narrow legal issue as paired with a legal issue outcome, one or more material facts, one or more fact patterns, a level of concreteness (e.g., concrete or abstract), one or more causes of action, one or more party types, one or more governing laws (e.g., a state law, a federal law, an administrative rule, and so on), one or more motion types (e.g., motion to dismiss, motion for summary judgment, motion to stay, motion for judgment as a matter of law, and so on), one or more motion outcomes, one or more motion types as paired with motion outcomes, one or more areas of law (e.g., contracts, torts, product liability, criminal law, cybersecurity, or any number of additional areas of law), a headnote number, or some combination of the above. The examples of attributes and/or parameters associated with selectable elements listed above are intended as illustrative examples and are not intended to limit the attributes which may be associated with selectable elements provided via a GUI in accordance with the concepts disclosed herein. Those of skill in the art would recognize that other attributes could be similarly identified by, associated with, and/or incorporated into selectable elements of a graphical user interface.

In some implementations, when a query is received, preprocessing may be done to the query. For example, text input to a query as natural language may be converted into a computer-readable format using natural language processing. In some example implementations, if a query is received with Boolean operators such as AND or OR, grammatical connectors such as /p or /s (terms within the same paragraph or sentence, respectively), and/or numerical connectors such as /n (terms within n terms of each other), such terms may be converted to a natural language search for purposes of identifying the most relevant headnote(s). For example, if a given query was input as “(privacy /2 policy) /p (revis! OR subseq!)” the operators could be removed and the query revised to become a natural language query. In the above example, the resulting natural language query might be transformed into “privacy policy revised subsequence” and a query with this natural language could be generated. Another preprocessing rule may be to remove non-content fields, such as a judge's name, from the query. Other non-exclusive examples of non-content fields that may be removed by preprocessing rules are fields indicating the date of documents, court names, attorney names, and citations. For content fields, preprocessing rules may remove the name or abbreviation of the field and extraneous field indicators like parentheses.

Other rules may be applied to a query as part of preprocessing. For example, if a query is directed to retrieving a specific case, as opposed to researching a legal issue, the case may be retrieved without retrieving headnotes to a legal issue. For example, a query containing a “v.” or a “v” such as a query to “Smith v. Jones” may be directed to retrieving a case directly. Another example of a query seeking to retrieve a case specifically might be by reference to a docket number or a reporter page number. Similarly, queries directed to retrieving cases that cite a particular statute or regulation may be retrieved without retrieving headnotes to a legal issue. For example, a query for 15 USC 1333 may be directed to retrieving a category of case rather in a manner similar to a search of a non-content field. An example of another potential preprocessing rule might be to limit any query consisting solely of a pattern of numeric and non-numeric characters that tend to make up a citation. Another example of a preprocessing rule might be determining whether the query includes the term “elements.” In such a case, a user may not be seeking to identify concrete headnotes related to a legal issue but may instead be more interested in an abstract listing of the elements for the legal issue. Thus, generating a headnote optimized to such a query may not be necessary. For queries which are not limited by such preprocessing rules, the techniques of this disclosure may be applied to the queries and headnotes according to aspects of the disclosure.

In an aspect, the ranking engine 120 may be configured to generate, by the one or more processors 112, a set of headnote scores for a plurality of headnotes. The plurality of headnotes may include or correspond to headnotes stored on a headnote database of the one or more databases 118. In an aspect, each headnote score of the set of headnote scores may include or correspond to a particular headnote of the plurality of headnotes. In other words, each headnote may have its own headnote score.

In an aspect, the headnote score is generated for each headnote based on the query. A headnote score may indicate or correspond to how similar a portion of a particular headnote is to the terms of a query. In an aspect, a first headnote score may correspond to a first headnote of the subset of headnotes is based on information associated with a first portion of the first headnote. For example, a headnote may include substantive information, such as, for example, a summary of a point of law. In some implementations, headnote scores may be generated using an elastic search method. In some such implementations, the headnote score may indicate a similarity between the substantive information and the query. A headnote may also include a second portion and/or other portions containing information different from the information associated with the first portion of the headnote. For example, the headnote may also include or correspond to metadata, such as has been discussed above with reference to the metadata database of the one or more databases 118. In some implementations, headnote scores may not be generated based on metadata. However, some categories of metadata may be relevant for the headnote score. For example, a material facts metadata may improve the correlation between the headnote and a query seeking information related to such material facts. That said, if such metadata would be relevant enough to the query to impact the headnote score, then it is more likely that the substantive information (e.g., the summary of a point of law) would also contain such information. Even in case in which the metadata is not used to generate the headnote score, the metadata may be still useful for later classification and ranking of the headnotes. Although the metadata of a given headnote may correspond to the substance of a given headnote, they need not correspond to one another. In an aspect, for example, the information associated with the first portion of the first headnote may be different from the information associated with the second portion of the first headnote.

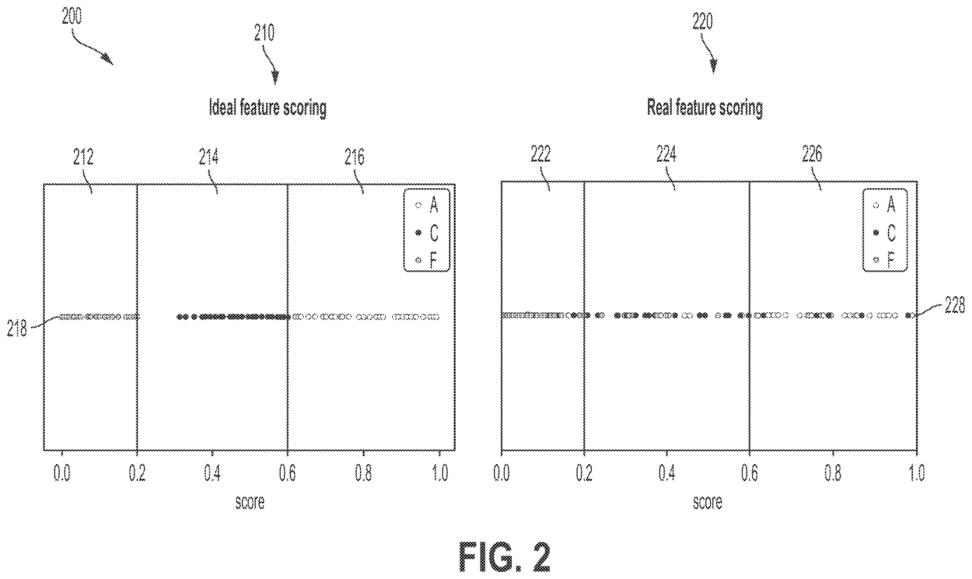

Reference is now made to FIG. 2, which shows a diagram illustrating exemplary scoring data generated in accordance with aspects of the present disclosure as a data visualization 200. Data visualization 200 includes an ideal feature scoring visualization 210 and a real feature scoring visualization 220. The ideal feature scoring visualization 210 illustrates scoring brackets 212, 214, and 216, and a plurality of datapoints 218. The real feature scoring visualization 220 illustrates scoring brackets 222, 224, and 226, and a plurality of datapoints 228. The pluralities of datapoints 218 and 228 may be a representation of headnote scores, such as the headnote scores generated by ranking module 120. Each headnote score may correspond to an individual headnote's correlation, responsiveness, and/or similarity to a query.

In some instances, the headnote scores on their own may indicate perfectly how well a headnote corresponds to a given query. In the example of FIG. 2, the plurality of datapoints 218 fit neatly into different scoring brackets or strata, and thus it becomes easy to identify the highest scoring headnote. For example, a grade may be assigned to headnote scores based on their score. The grade may include or correspond to how well a particular headnote responds to the query. In the example of FIG. 2, the headnote scores below 0.2 in scoring bracket 212 correspond to a grade of F, the headnote scores between 0.2 and 0.6 correspond to a grade of C in scoring bracket 214, and the headnote scores above 0.6 correspond to a grade of A in scoring bracket 216. In the ideal case then, there is a perfect correlation between a headnote score and a grade, and the datapoint with the highest score would be related to the most responsive headnote to a given query.

Real-world data is more difficult to score and classify. There are several potential sources of variation between headnotes and queries. For example, queries are not always generated in a way that enables ready identification of relevant and responsive headnotes. There may be variations in how a headnote is classified or drafted. There may be important nuances in the law that result in variations between cases, even cases having similar facts. For example, the plurality of datapoints 228 in real feature scoring visualization 220 are much more spread out and intermixed. In this example, some F-graded headnotes (e.g., headnotes which are unsuitable and/or unresponsive to the query) may nonetheless have a headnote score in the score bracket 224. In other words, a false positive result may be possible for some headnotes with respect to a given query. Similarly, some C-graded datapoints spread across the entire data range, even up to nearly a score of 1.0, and a similar spread may be seen for the A-graded headnotes. The variations in the C-graded headnotes and A-graded headnotes may also result in false negative results. Thus, it may be difficult to identify the most responsive headnote from a headnote score alone.

There are methods by which the ranking engine 120 may compensate for the variation in headnote scores and produce consistent scoring results. For example, the headnote score may take into account that a query may identify more than one search parameter (e.g., a feature or attribute of interest) and the intersection of such parameters may be reflected in headnote scores having a stronger correlation to the query. Headnote scores can be normalized to account for multiple parameter inputs. A non-limiting example of normalization to produce consistent scoring results is max score normalization, where each headnote score is divided by the max score, where the max score is the score of a hypothetical best headnote in the entire headnote collection. Normalized headnote scores allow for decisions to be made based on the scores such as ignoring headnotes with a low normalized score.

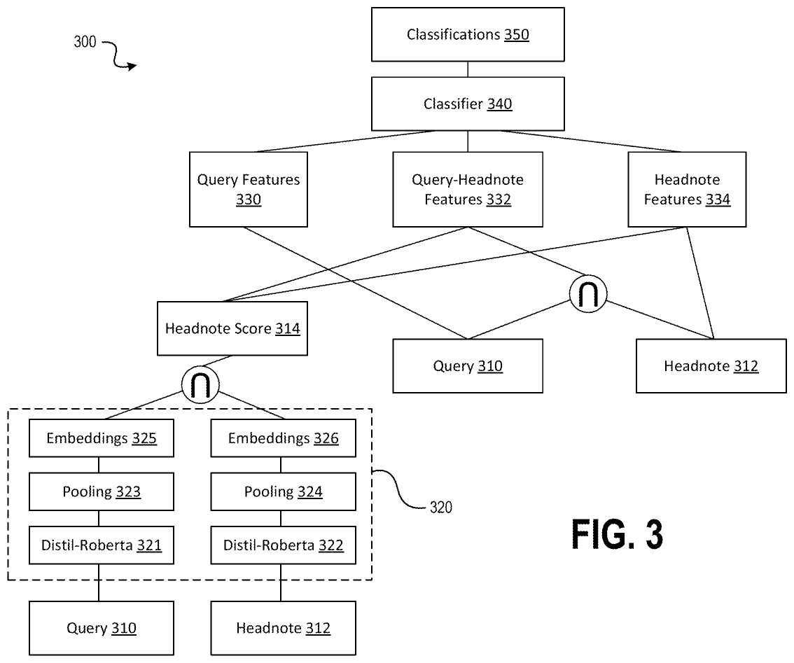

Reference is now made to the example of FIG. 3, which shows a block diagram illustrating an example architecture for a scoring model in accordance with aspects of the present disclosure as a model 300. Model 300 takes as inputs a query 310, a headnote 312, and a headnote score 314. In some implementations, the ranking engine 120 may generate a set of headnote scores by determining a similarity between the query and each headnote of the plurality of headnotes. The ranking engine 120 may calculate a headnote score for each headnote of the plurality of headnotes based on the similarity. In an aspect, the set of headnote scores may include the headnote score calculated for each headnote of the plurality of headnotes.

In one example, a similarity between the headnotes and the query may be determined using embeddings. For example, the headnote score 314 of FIG. 3 may be determined as a result of an embeddings model 320. For example, the embeddings model 320 may generate a first set of embeddings 325 based on the query. The embeddings model 320 may similarly generate a second set of embeddings corresponding to and/or based on each headnote 312. In an aspect, the similarity may be determined for each headnote 312 of the plurality of headnotes based on the first set of embeddings 325 and the second set of embeddings 326. In an aspect, the headnote embeddings may be calculated at the time the query is received. For example, the headnote embeddings may be calculated dynamically as headnotes are identified as potentially relevant to a query. Alternatively, the headnote embeddings may be preprocessed. For example, the headnote embeddings may be calculated in advance so as to be retrieved at the time a headnote is identified as potentially relevant to a query. As a further example, preprocessed headnote embeddings may be stored in a database of the one or more databases 118 and may in some implementations be indexed for relatively quick retrieval.

The embeddings model 320 may be a language model, such as, for example, a transformer model, or a vector space model. Non-limiting examples of transformer models which may be used include Bidirectional Encoder Representations from Transformers (BERT) models, distilled versions of BERT, XLNet models, and RoBERTa models. In the example of FIG. 3, Distil-RoBERTa is illustrated as an example embeddings model. In this particular example, a query 310 is transmitted to a distil-RoBERTa model 321. The results/outputs of the distil-RoBERTa model 321 may then be pooled at pooling operation 323 to generate a set of query embeddings 325 from the sequence embeddings generated by distil-RoBERTa 321. A similar Distil-BERT model may be applied to the headnote 312. For example, the text of the headnote may be transmitted to a distil-RoBERTa model 322. In an additional or alternative aspect, metadata may also be provided as an input (or additional input) to the distil-RoBERTa model 322. As a non-limiting example, the metadata may include a classification of the headnote (e.g., a key number catch line). The outputs of the distil-Roberta model may be pooled at pooling operation 324 to generate a set of headnote embeddings 326 from the sequence embeddings generated by distil-RoBERTa 322. The two embeddings may include or correspond to embedding vectors. An example of embedding in a vector space model is a vector encoding the term frequency of keywords in the query and headnotes. In an aspect, the embedding vectors may be compared for similarities. In an aspect, the headnote score 314 may be generated by calculating a similarity between the query embedding vector and the headnote embedding vector. For example, a similarity may be calculated based on a cosine similarity, a dot-product similarity, an improved square root cosine similarity, some other metric by which the embedding vectors may be reasonably compared, or a combination thereof. Based on the parameters of a particular set of headnotes, one method of determining a similarity may be preferred over another.

Referring to FIG. 1, the ranking engine 120 may be configured to apply a classifier to a dataset to generate a set of classifications. In an aspect, the classifier may provide for greater level of precision in classifying a dataset over the use of a headnote score alone. For example, the classifier 340 may be a feature model. Features may encode specific aspects of the relationships between a query and individual or a plurality of headnotes. A feature model may learn an optimal combination of these features (e.g., during training), where learning makes use of examples specifically curated for that purpose. The dataset may include the headnote score, the query, and information associated with at least a subset of headnotes of the plurality of headnotes. For example, the information may include metadata associated with the headnotes. The metadata may include such categories as have been discussed previously with respect to the metadata database 118. Not every headnote of the plurality of headnotes may include such metadata, but for the headnotes which do include such metadata (e.g., for a subset of headnotes), the metadata may be transmitted to the classifier to facilitate in classifying the dataset. Additionally or alternatively, the subset of headnotes may also include or correspond to a subset of headnotes determined to be relevant to the query. For example, the subset of headnotes may correspond to a set of search results (e.g., case documents) initially identified by the search engine 122. The set of classifications generated may include a classification for each headnote of the subset of headnotes.

Referring again to FIG. 3, the classifier 340 may anticipate inputs having specific characteristics and/or features, such as, for example, feature vectors or embeddings vectors. In an aspect, features from the query 310, each headnote 312 and its corresponding headnote score 314 may be extracted and input to the classifier 340. For example, a set of query features 330 may be extracted from the query 310. The query features 330 may include or correspond to search parameters, to metadata, to selected attributes of interest, identified keywords, text identified through natural language processing of the query 310, some other relevant aspect of the query, or a combination thereof. As another example, the query features 330 may include a query length feature (e.g., a number of characters in the query), a query words feature (e.g., the number of words in the query), a feature identifying whether the query includes a number, an embeddings max value feature (e.g., the highest value of a query embeddings vector), an embeddings second max value feature (e.g., the second highest value of a query embeddings vector), an embeddings third max value feature (e.g., the third highest value of a query embeddings vector), an argmax feature (e.g., an argmax of the query embeddings vector), a second argmax feature (e.g., a second argmax of the query embeddings vector), a third argmax feature (e.g., a third argmax of the query embeddings vector), an embeddings mean feature (e.g., the mean of the query embeddings vector), an embeddings standard deviation feature (e.g., the standard deviation of the query embeddings vector), or a combination thereof.

In an aspect, the query 310, the headnote 312, and the headnote score 314 may be analyzed to determine a set of query-headnote features 332. For example, the query-headnote features may include a number matching feature (e.g., a count of common numbers), a matching words feature (e.g., a sum of common word length), a matching codes feature (e.g, a count of common numbers removing formatting or special characters), a longest substring feature (e.g., the length of the longest substring between the query 310 and the headnote 312), a diff_vector_norm feature (e.g., a norm of the vectorial subtraction between the query and headnote embeddings vectors), a normalized dot product feature (e.g., a dot product between the query and headnote embeddings vectors normalized by the norm of the query embedding vector), an improved sqrt-cosine similarity feature (e.g., a determination of an improved sqrt-cosine similarity for the embedding vectors), a score to evaluate a positive reward when associated with connected words and a negative reward for unconnected words, and/or a term frequency feature (e.g., a feature for introducing a TF-IDF feature; in some implementations, the assumption that IDF is 1 may be a good assumption for short headnotes).

As another example, the headnote 312 and the headnote score 314 may be analyzed to determine a set of headnote features 334. For example, the headnote features may include a headnote length feature (e.g., a number of characters in a headnote), a headnote words feature (e.g., the number of words in the headnote), a headnote sentences feature (e.g., the number of sentences in the headnote), an Embeddings Max Value feature (e.g., the highest value of the headnote embeddings vector), an Embeddings Second Max Value feature (e.g., the second highest value of the headnote embeddings vector), an Embeddings Argmax feature (e.g., an Argmax of the headnote embeddings vector), an Embeddings Second Argmax feature (e.g., the second argmax of the headnote embeddings vector), an Embeddings Std. Dev. Feature (e.g., the standard deviation of the headnote embeddings vector), or some combination thereof.

The classifier 340 may include a machine learning model trained on data including a training dataset of query features, headnote features, and/or query-headnote features. The classifier 340 may be configured to classify the dataset and generate a set of classifications 350. Each classification of the set of classifications may include or correspond to a classification for each headnote of at least the subset of headnotes. In an aspect, each classification of the set of classifications 350 may include or correspond to a relevance score for a particular headnote (e.g., a measure of how responsive the headnote is to the query). For example, the classification (e.g. relevance score) could include a real value (e.g. a value from 0 to 1 where 1 is a very responsive headnote for a given query), a discrete value such as a grade or a category (e.g., a grade of A may correspond to a highly responsive headnote, a grade of C may correspond to a responsive headnote, and a grade of F may correspond to a non-responsive headnote) or a binary value (e.g., a value of 1 for responsive headnotes and a value of 0 for not responsive headnotes). The classifications 350 may be similar to the headnote scores, or may deviate from the headnote scores based on the dataset input to the classifier 340. In an aspect, the classifications 350 may be a fine-tuned set of results from the headnote scores.

Although the classifier 340 and the headnote score 316 of FIG. 3 have been described as being applied in determining a headnote score for a single headnote, the same or a similar process could be applied to multiple headnotes to generate a set of headnote scores, with a headnote score for each headnote according the techniques of this disclosure. Likewise, while the plurality of headnotes has been described in some illustrative examples with reference to a headnote database, the ranking engine 120 may not include every headnote in a headnote database in determining a headnote score. For example, in cases involving a narrow legal issue of a breach of contract, headnotes related to criminal procedure may not be included in determining headnote scores. Metadata may be helpful in these instances for determining which headnotes are relevant enough to be considered for a headnote score.

The ranking engine 120 may be configured to rank the subset of headnotes based at least in part on the set of classifications and the set of headnote scores. The ranking of headnotes may produce a ranked set of headnotes. In an aspect, the ranked set of headnotes may be configured to quantify a relevance of each headnote of the subset of headnotes to the query. For instance, the ranking may be based on the information associated with a second portion of a given headnote (e.g., based at least in part on metadata and/or based on a set of headnote features). In an aspect, the information associated with the second portion of the given headnote may include different information than a first portion of the headnote. In an example, the first portion of the headnote may include the text of the headnote itself.

The ranking of the headnotes may be determined dynamically. For example, the headnote rankings may be generated as queries are received. Alternatively, in some instances, headnotes relevant to a query may be predetermined for a particular types of query. For example, in the example of a set of frequently asked questions (FAQ) around a particular legal issue, the most responsive headnote may already have been determined, stored, and/or indexed, so it may be presented more quickly.

The ranking may determine a highest ranked headnote. For example, the highest ranked headnote may be the headnote with the highest classification and/or the highest headnote score. In some aspects, the highest ranked headnote may be determined from among a subset of headnotes satisfying a threshold value. For example, in implementations in which headnotes are classified with a grade, a headnote may be considered as the highest ranked headnote if it has a grade of C or A (and may be excluded if it has a grade of F). In other exemplary implementations in which a numerical value representing relevance is assigned to each headnote, headnotes with a score greater than a set threshold may be considered for the ranking.

The ranking of headnotes may be based on a set of ranking features. For example, ranking features for a given query may be determined when a query is generated from inputs to a graphical user interface (e.g., selections from a plurality of selectable elements) corresponding to attributes of interest. In other instances, relevant ranking features may be extracted from the headnotes and/or queries while headnote scores and/or classifications are being determined. Relevant ranking features may also be identified and/or extracted from a query in preprocessing stages (e.g., natural language processing).

Non-limiting examples of ranking features may include the set of headnote scores, the set of classifications, a narrow legal issue feature, an outcome feature, a material fact feature, a fact pattern feature, an outcome, a cause of action feature, a concreteness metric, a party type feature, a governing law feature, a motion type feature, an area of law feature, a count of matching attributes, a count of matching terms from material facts, a headnote number, a grade, or a combination thereof. Note that for some examples of ranking features, there is some overlap with example selectable elements, attributes of interest, and headnote metadata. For example, headnotes may include material fact metadata, a query may be generated by selecting a selectable element corresponding to a material fact attribute of interest, and the resulting headnotes may be ranked based on whether they contain a relevant material fact. Nonetheless, there is a distinction in application between these categories. For example, the ranking features may operate independently from one another or from attributes of interest or metadata. For example, a query may be generated using a selectable element corresponding to a fact pattern attribute of interest, headnotes generated in response may include no fact pattern metadata but may include a governing law metadata, and the headnotes may be ranked based more on an outcome ranking feature than on other ranking features.

In one particular example in accordance with aspects of the disclosure, ranking features may be ordered such that classified headnotes are ranked in order of the following ranking features:
(1) Narrow Legal Issue+Outcome
(2) Narrow Legal Issue
(3) Material Facts
(4) Fact Pattern
(5) Cause of Action
(6) Concreteness
(7) Party Type
(8) Governing Law
(9) Motion Type
(10) Area of Law
(11) Count of matching attributes
(12) Count of matching terms from Material Facts
(13) Headnote number.
   These ranking features may be applied recursively. For example, the ranking may check for each ranking feature in succession, and then check again in succession to break any ties. In an aspect, recursive application enables for higher priority ranking features to serve as tiebreakers. In the example above, if two headnotes were determined to each have applicable material facts, but a first headnote was concrete and the second headnote was abstract, the first headnote would be ranked higher than the second headnote in the ranked set of headnotes. Similarly, if a concreteness was not determined for the second headnote and it only identified a motion type, the first headnote would be ranked higher in the ranked set of headnotes.

The ranking engine 120 may be configured to output the highest ranked headnote based on the ranked set of headnotes. There are several ways in which the highest ranked headnote may be output. For example, the highest ranked headnote may be output visually to one of the I/O devices 126 such as a display, or to a GUI. Alternatively or additionally, the highest ranked headnote may be output by a message (e.g., by an email or SMS message), by transmitting the highest ranked headnote to the computing device 110, and/or storing the highest ranked headnote in a memory and/or a database.

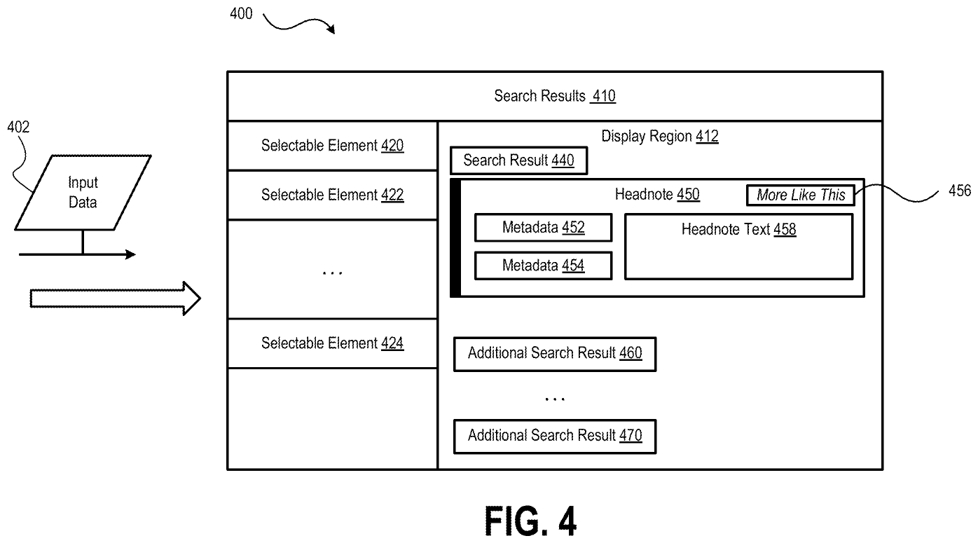

Reference is now made to FIG. 4, which illustrates an exemplary graphical user interface for displaying information associated with search results and/or headnotes obtained in accordance with aspects of the present disclosure as a GUI 400. GUI 400 may be generated in response to input data 402. For example, input data 402 may include or correspond to a query, a selection of selectable elements, some other form of input data, or a combination thereof. GUI 400 includes a set of search results 410, a display region 412, a plurality of selectable elements including selectable element 420, selectable element 422, and so on through selectable element 424. The set of search results may be displayed in the display region 412 and may include search result 440, additional search result 460, and so on up to additional search result 470. The set of search results may also include a headnote display 450. Headnote display 450 may include a metadata 452, a metadata 454, a selectable element 456, and a headnote text 458.

In an aspect, headnote display 450 may include or correspond to a highest ranked headnote determined according to aspects described herein. The headnote display 450 may include metadata associated with the headnote. The metadata may be displayed based on its relevance to the query. For example, the metadata 452 or may identify a narrow legal issue addressed by the headnote, material facts addressed by the headnote, or any other category of metadata relevant for display. In an aspect, the headnote text 458 may include all or a portion of the text (e.g., summary of a point of law) of the highest ranked headnote.

In some implementations, the headnote display 450 may be formatted or displayed in such a way that it may stand out in the display region. This may help a user more quickly identify that a highest ranked headnote is being shown in response to a query. For example, the headnote display 450 may appear different from the rest of the display region 412, by having, for example have a different border style, a different typeface, a different background color, some other formatting measure(s) designed to aid in distinguishing the headnote display 450, or a combination thereof. It is expressly understood that FIG. 4 is intended as an illustration and not as a limitation of the kinds of information and/or formatting that may be output in accordance with aspects of this disclosure.

Headnote display 450 may include one or more selectable elements 456. In an aspect, the selectable element 456 may include or correspond to functionality for identifying similar headnotes. In a particular example, the selectable element 456 may prompt a user to view “more like this” or to “view more cases on this issue.” In an aspect, selection of the selected element 456 may cause the computing device 110 to display results similar to the headnote. In an example, in response to an input to a graphical user interface, the computing device may, by the one or more processors 112, retrieve additional headnotes. Each headnote of the additional headnotes may have a headnote score satisfying a threshold similarity to the headnote score of the highest ranked headnote. For example, other headnotes from the ranked set of ranked headnotes may be displayed. The other headnotes may be ranked (e.g., for relevance). The other headnotes may be displayed according to their rank, but need not be so.

In an aspect, selectable elements may also be included for either or each of the metadata 452 and 454. For example, this may enable a user to search for additional headnotes and/or documents related to the legal issue at interest in greater detail.

In an aspect, the computing device 110 may be configured to modify an order of the ranked set of headnotes to produce a modified ranked set of headnotes in response to one or more inputs received via a graphical user interface. The one or more inputs may identify attributes of interest. For example, the selectable elements 420, 422, or 424 may include or correspond to attributes of interest. Upon selection of an attribute of interest via a selectable element, a weight of one or more of the ranking features may be modified based on the attributes of interest identified by the one or more inputs. The ranking feature to be modified may correspond to the attribute of interest, but it need not do so. For example, if a narrow legal issue attribute of interest is selected, the ranking feature related to narrow legal issues may be reweighted, but other ranking features may also be reweighted. The modified ranked set of headnotes may result in a new highest ranked headnote. The process of modifying an order of the ranked set of headnotes may be repeated to revise, narrow, expand, or otherwise adjust the ranking of headnotes. For example, this may include modifying the modified ranked set of headnotes in response to an additional input received via the graphical user interface.

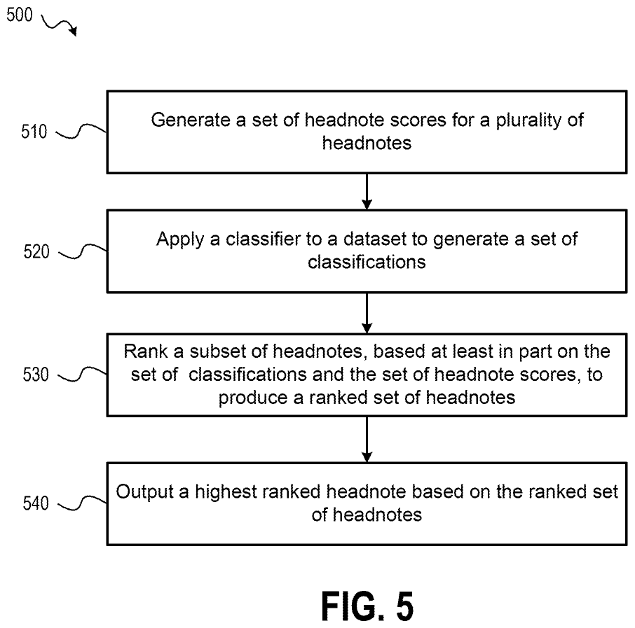

Referring to FIG. 5, a flow diagram of an exemplary method for outputting a headnote in accordance with aspects of the present disclosure is shown as a method 500. At step 510, the method 500 may include generating, by one or more processors, a set of headnote scores for a plurality of headnotes. In an aspect, as explained above relative to FIGS. 1-3, each headnote score of the set of headnote scores may include or correspond to a particular headnote of the plurality of headnotes. In an aspect the headnote score is generated for each headnote based on a query.

At step 520, the method 500 may include applying, by the one or more processors, a classifier to a dataset to generate a set of classifications. As explained above with reference to FIGS. 1 and 3, in some implementations, the dataset may include the headnote score, the query, and information associated with at least a subset of headnotes of the plurality of headnotes. In an aspect, the set of classifications may include or correspond to a classification for each headnote of the subset of headnotes.

At step 530, the method 500 may include ranking, by the one or more processors, the subset of headnotes, based at least in part on the set of classifications and the set of headnote scores to produce a ranked set of headnotes. As discussed above with respect to FIGS. 1 and 3, in an aspect, the ranked set of headnotes may be configured to quantify a relevance of each headnote of the subset of headnotes to the query. In an aspect, a first headnote score corresponding to a first headnote of the subset of headnotes may be based on information associated with a first portion of the first headnote. In an aspect, a ranking of the first headnote may be based on information associated with a second portion of the first headnote. In an aspect, the information associated with the first portion of the first headnote may be different from the information associated with the second portion of the first headnote.

At step 530, the method 500 may include outputting, by the one or more processors, a highest ranked headnote based on the ranked set of headnotes. As discussed above with respect to FIGS. 1 and 4, there are several potential methods of outputting the highest ranked headnote. For example, the highest ranked headnote may be output to a GUI such as GUI 400 of FIG. 4.

The method 500 may include other steps and/or substeps, and the steps described above may include additional details. In some implementations, for example, the subset of headnotes may be ranked based at least in part on a set of ranking features. As discussed above, the set of ranking features may include, as non-limiting examples, the set of headnote scores, the set of classifications, a narrow legal issue feature, an outcome feature, a material fact feature, a fact pattern feature, a cause of action feature, a concreteness metric, a party type feature, a governing law feature, a motion type feature, an area of law feature, a count of matching attributes, a count of matching terms from material facts, a headnote number, a grade, or a combination thereof.

In some implementations, the method 500 may include modifying an order of the ranked set of headnotes to produce a modified ranked set of headnotes in response to one or more inputs received via a graphical user interface. In such implementations, the one or more inputs may identify attributes of interest. Additionally or alternatively, in some such implementations, a weight of one or more of the ranking features may be modified based on the attributes of interest identified by the one or more inputs. In some additional implementations, the method 500 may include modifying an order of the modified ranked set of headnotes in response to an additional input received via the graphical user interface.

In some implementations, the method 500 may include receiving one or more inputs identifying one or more attributes of interest. In some such implementations, the query may be generated based on the one or more inputs. In an aspect, the one or more inputs may be received via selectable elements of a graphical user interface.

In some implementations of the method 500, as discussed above with respect to FIGS. 1 through 3, generating the set of headnote scores may include determining a similarity between the query and each headnote of the plurality of headnotes. In an aspect, generating the set of headnote scores may include calculating a headnote score for each headnote of the plurality of headnotes based on the similarity. Additionally or alternatively, the set of headnote scores may include the headnote score calculated for each headnote of the plurality of headnotes. In some further implementations, the method 500 may include generating a first set of embeddings based on the query and generating a second set of embeddings corresponding to each headnote. In an aspect, the similarity may be determined for each headnote of the plurality of headnotes based on the first set of embeddings and the second set of embeddings.

In some implementations, as discussed above with respect to FIGS. 1 and 4, the method of claim 1, the method 500 may include, in response to an input to a graphical user interface, retrieving additional headnotes. In an aspect, each headnote of the additional headnotes may have a headnote score satisfying a threshold similarity to the headnote score of the highest ranked headnote. In some such implementations, the method 500 may further include ranking the additional headnotes.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

1. A method, comprising:
generating, by one or more processors, a set of headnote scores for a plurality of headnotes, wherein each headnote score of the set of headnote scores corresponds to a particular headnote of the plurality of headnotes, and wherein the headnote score is generated for each headnote based on a query;
applying, by the one or more processors, a classifier to a dataset to generate a set of classifications, wherein the dataset comprises the headnote score, the query, and information associated with at least a subset of headnotes of the plurality of headnotes, and wherein the set of classifications comprises a classification for each headnote of the subset of headnotes;
ranking, by the one or more processors, the subset of headnotes, based at least in part on the set of classifications and the set of headnote scores to produce a ranked set of headnotes, wherein the ranked set of headnotes is configured to quantify a relevance of each headnote of the subset of headnotes to the query; and
outputting, by the one or more processors, a highest ranked headnote based on the ranked set of headnotes.

2. The method of claim 1, wherein the subset of headnotes are ranked based at least in part on a set of ranking features, wherein the set of ranking features comprises the set of headnote scores, the set of classifications, a narrow legal issue feature, an outcome feature, a material fact feature, a fact pattern feature, a cause of action feature, a concreteness metric, a party type feature, a governing law feature, a motion type feature, an area of law feature, a count of matching attributes, a count of matching terms from material facts, a headnote number, a grade, or a combination thereof.

3. The method of claim 2, further comprising modifying an order of the ranked set of headnotes to produce a modified ranked set of headnotes in response to one or more inputs received via a graphical user interface, wherein the one or more inputs identify attributes of interest, and wherein a weight of one or more of the ranking features is modified based on the attributes of interest identified by the one or more inputs.

4. The method of claim 3, further comprising modifying an order of the modified ranked set of headnotes in response to an additional input received via the graphical user interface.

5. The method of claim 2, further comprising receiving one or more inputs identifying one or more attributes of interest, wherein the query is generated based on the one or more inputs, and wherein the one or more inputs are received via selectable elements of a graphical user interface.

6. The method of claim 1, wherein generating the set of headnote scores comprises:
determining a similarity between the query and each headnote of the plurality of headnotes; and
calculating a headnote score for each headnote of the plurality of headnotes based on the similarity, wherein the set of headnote scores includes the headnote score calculated for each headnote of the plurality of headnotes.

7. The method of claim 6, further comprising:
generating a first set of embeddings based on the query; and
generating a second set of embeddings corresponding to each headnote, wherein the similarity is determined for each headnote of the plurality of headnotes based on the first set of embeddings and the second set of embeddings.

8. The method of claim 1, further comprising, in response to an input to a graphical user interface, retrieving additional headnotes, each headnote of the additional headnotes having a headnote score satisfying a threshold similarity to the headnote score of the highest ranked headnote.

9. The method of claim 8, further comprising ranking the additional headnotes.

10. A system, comprising:
a memory; and
one or more processors, the one or more processors configured to perform steps comprising:
generating, by the one or more processors, a set of headnote scores for a plurality of headnotes, wherein each headnote score of the set of headnote scores corresponds to a particular headnote of the plurality of headnotes, and wherein the headnote score is generated for each headnote based on a query;
applying, by the one or more processors, a classifier to a dataset to generate a set of classifications, wherein the dataset comprises the headnote score, the query, and information associated with at least a subset of headnotes of the plurality of headnotes, and wherein the set of classifications comprises a classification for each headnote of the subset of headnotes;
ranking, by the one or more processors, the subset of headnotes, based at least in part on the set of classifications and the set of headnote scores to produce a ranked set of headnotes, wherein the ranked set of headnotes is configured to quantify a relevance of each headnote of the subset of headnotes to the query; and
outputting, by the one or more processors, a highest ranked headnote based on the ranked set of headnotes.

11. The system of claim 10, wherein the subset of headnotes are ranked based at least in part on a set of ranking features, wherein the set of ranking features comprises the set of headnote scores, the set of classifications, a narrow legal issue feature, an outcome feature, a material fact feature, a fact pattern feature, a cause of action feature, a concreteness metric, a party type feature, a governing law feature, a motion type feature, an area of law feature, a count of matching attributes, a count of matching terms from material facts, a headnote number, a grade, or a combination thereof.

12. The system of claim 11, further comprising modifying an order of the ranked set of headnotes to produce a modified ranked set of headnotes in response to one or more inputs received via a graphical user interface, wherein the one or more inputs identify attributes of interest, and wherein a weight of one or more of the ranking features is modified based on the attributes of interest identified by the one or more inputs.

13. The system of claim 11, further comprising receiving one or more inputs identifying one or more attributes of interest, wherein the query is generated based on the one or more inputs, and wherein the one or more inputs are received via selectable elements of a graphical user interface.

14. The system of claim 10, wherein generating the set of headnote scores comprises:
determining a similarity between the query and each headnote of the plurality of headnotes; and
calculating a headnote score for each headnote of the plurality of headnotes based on the similarity, wherein the set of headnote scores includes the headnote score calculated for each headnote of the plurality of headnotes.

15. The system of claim 14, wherein generating the set of headnote scores comprises:
generating a first set of embeddings based on the query; and
generating a second set of embeddings corresponding to each headnote, wherein the similarity is determined for each headnote of the plurality of headnotes based on the first set of embeddings and the second set of embeddings.

16. The system of claim 10, further comprising:
in response to an input to a graphical user interface, retrieving additional headnotes from the plurality of headnotes, each headnote of the additional headnotes having a headnote score satisfying a threshold similarity to the headnote score of the highest ranked headnote; and
ranking the additional headnotes.

17. A computer program product, comprising:
a non-transitory computer readable medium comprising code for performing steps comprising:
generating, by one or more processors, a set of headnote scores for a plurality of headnotes, wherein each headnote score of the set of headnote scores corresponds to a particular headnote of the plurality of headnotes, and wherein the headnote score is generated for each headnote based on a query;
applying, by the one or more processors, a classifier to a dataset to generate a set of classifications, wherein the dataset comprises the headnote score, the query, and information associated with at least a subset of headnotes of the plurality of headnotes, and wherein the set of classifications comprises a classification for each headnote of the subset of headnotes;
ranking, by the one or more processors, the subset of headnotes, based at least in part on the set of classifications and the set of headnote scores to produce a ranked set of headnotes, wherein the ranked set of headnotes is configured to quantify a relevance of each headnote of the subset of headnotes to the query; and
outputting, by the one or more processors, a highest ranked headnote based on the ranked set of headnotes.

18. The computer program product of claim 17, wherein the subset of headnotes are ranked based at least in part on a set of ranking features, wherein the set of ranking features comprises the set of headnote scores, the set of classifications, a narrow legal issue feature, an outcome feature, a material fact feature, a fact pattern feature, a cause of action feature, a concreteness metric, a party type feature, a governing law feature, a motion type feature, an area of law feature, a count of matching attributes, a count of matching terms from material facts, a headnote number, a grade, or a combination thereof.

19. The computer program product of claim 18, further comprising receiving one or more inputs identifying one or more attributes of interest, wherein the query is generated based on the one or more inputs, and wherein the one or more inputs are received via selectable elements of a graphical user interface.

20. The computer program product of claim 17, further comprising:
in response to an input to a graphical user interface, retrieving additional headnotes from the plurality of headnotes, each headnote of the additional headnotes having a headnote score satisfying a threshold similarity to the headnote score of the highest ranked headnote; and
ranking the additional headnotes.
